(19) United States
(12) Patent Application Publication
(10) Pub. No.: US 2013/0020832 A1
(43) Pub. Date: Jan. 24, 2013

(54) REINFORCING ELEMENT FOR REFORCEMENT IN CAVITIES OF STRUCTURAL COMPONENTS

(71) Applicant: SIKA Technology AG, Baar (CH)

(72) Inventors: Jürgen FINTER, Zurich (CH); Matthias Gössi, Uster (CH); Karsten Frick, Remetschwil (CH); Norman Blank, Ruschlikon (CH)

(73) Assignee: SIKA TECHNOLOGY AG, Baar (CH)

(21) Appl. No.: 13/627,202

(22) Filed: Sep. 26, 2012

Related U.S. Application Data
(63) Continuation of application No. PCT/EP2011/054651, filed on Mar. 25, 2011.

(30) Foreign Application Priority Data
Mar. 26, 2010 (EP) 10158078.5

(51) Int. Cl. B60R 99/00; B32B 37/06; B32B 37/12

(52) U.S. Cl. 296/187.01; 156/293; 156/275.5

(57) ABSTRACT

A reinforcing element for reinforcement in cavities of structural components including a substrate made of a plastics material, which is at least partially coated with a metal; and a foamable, thermosetting structural adhesive which is applied to the metal coating of the substrate; or a thermosetting structural adhesive which is applied to the metal coating of the substrate and is designed as a shape memory material.

### RELATED APPLICATION(S)

This application claims priority as a continuation application under 35 U.S.C. §120 to PCT/EP2011/054651, which was filed as an International Application on Mar. 25, 2011 designating the U.S., and which claims priority to European Application No. 10158078.5 filed in Europe on Mar. 26, 2010. The entire contents of these applications are hereby incorporated by reference in their entireties.

### FIELD

Disclosed are reinforcing elements for reinforcement in cavities of structural components, for example, which are suitable for use in car bodies and the like.

### BACKGROUND

In order to improve, for example, the mechanical properties of hollow structural components, as used in car bodies, for example, local reinforcing elements can be used or incorporated in the components. Such reinforcing elements can include a substrate, to which a structural adhesive is applied. The substrate can be made of a plastic material or a metal. An exemplary disadvantage of substrates made of a plastic material is that plastic materials that can be considered substrate materials, owing to their properties, such as mechanics and processability, and from an economic point of view, may not be adhesive with respect to structural adhesives. Substrates made of a metal, which also would be suitable owing to their properties, can be heavier, which can be undesirable, for example, in automotive engineering.

### SUMMARY

According to an exemplary aspect, a reinforcing element for reinforcement in cavities of structural components is provided, comprising: a) a substrate made of a plastic material, which is coated at least partially with a metal; and b) a foamable, thermosetting structural adhesive applied to the metal coating of the substrate, or a thermosetting structural adhesive which is applied to the metal coating of the substrate and which is designed as a shape memory material.

According to an exemplary aspect, a method for reinforcement in cavities of structural components is provided, the method comprising: a) placing the reinforcing element according to claim 1 in a cavity of a structural component; b) heating the thermosetting structural adhesive of the reinforcing element to a temperature above the glass transition temperature T_{g} of the thermosetting structural adhesive, wherein the temperature at which the thermosetting structural adhesive is heated is a foaming temperature of the foamable, thermosetting structural adhesive, or the temperature at which the thermosetting structural adhesive is heated is a temperature at which the shape memory material returns to its original shape; and c) curing the thermosetting structural adhesive.

### BRIEF DESCRIPTION OF THE DRAWINGS

Exemplary embodiments are shown in further detail in the drawings. Identical elements in the various figures are provided with identical reference numerals. The disclosure is not limited to the embodiment examples shown and described.

FIG. 1 is a schematic representation of a reinforcing element, according to an exemplary aspect;

FIG. 2 is a schematic representation of a reinforcing element with nails, according to an exemplary aspect;

FIG. 3 is a schematic representation of a reinforcing element with crimping, according to an exemplary aspect;

FIG. 4 is a schematic representation of the preparation of a reinforcing element, according to an exemplary aspect; and

FIG. 5 is a schematic representation of a method for reinforcing in a cavity of a structural component, according to an exemplary aspect.

Exemplary elements are shown in the figures.

### DETAILED DESCRIPTION

According to an exemplary aspect, a reinforcing element is provided which ameliorates or overcomes exemplary disadvantages of comparative reinforcing elements, and comprises a light-weight substrate which is adhesive with respect to structural adhesives.

It has been found that exemplary reinforcing elements which comprise a substrate made of a plastic material, which is coated at least partially with a metal, can be formed so they are light-weight, and adhesive with respect to structural adhesives.

A further exemplary benefit of exemplary reinforcing elements is that the structural adhesive which is located on the substrate, can be heated inductively by the metal layer, even in the case where the substrate includes plastic material to a large extent. For example, a possible temperature-caused shape changing process in the structural adhesive as well as the curing thereof can be controlled in a targeted manner, while saving energy and independently of other process steps.

A first exemplary aspect relates to a reinforcing element for reinforcing in cavities of structural components, comprising a substrate, which is made of a plastic material and is at least partially coated with a metal; and a foamable, thermosetting structural adhesive, which is applied to the metal coating of the substrate; or a thermosetting structural element, which is applied to the metal coating of the substrate and designed as a shape memory material.

Substance names starting with “poly,” such as, for example, polyisocyanate, polyurethane, polyester or polyol, include substances that formally contain two or more of the naturally occurring functional groups per molecule.

The term “polymer” includes, on the one hand, a group of chemically uniform macromolecules that can differ in terms of polymerization degree, molecular weight and chain length, and have been prepared by a poly reaction (polymerization, polyaddition, polycondensation). The term, on the other hand, also covers derivatives of such a group of macromolecules from poly reactions. The term can include compounds obtained by reactions, such as, for example, additions or substitutions, of functional groups on predetermined macromolecules, and that may be chemically uniform or not. The term also includes so-called prepolymers, which can include reactive oligomer prepolymers whose functional groups participate in the synthesis of macromolecules.

The term “polyurethane polymer” includes all the polymers that are produced by the so-called diisocyanate polyaddition method. This includes polymers that are nearly or completely free of urethane groups. Examples of polyurethane polymers are polyether-polyurethanes, polyester-polyurethanes, polyether-polyureas, polyureas, polyester-polyureas, polyisocyanurates and polycarbodiimides.

Exemplary suitable plastic materials for the substrates include polyurethanes, polyamides, polyesters and polyolefins and polyolefin copolymers, for example, high-temperature-resistant polymers, such as poly(phenylene ether), polysulfones or polyether sulfones. Exemplary plastic materials include polyamides (PA), such as PA6 or PA66, polyethylene or polypropylene, as well as polystyrene and copolymers, such as acrylonitrile butadiene styrene (ABS).

The plastic material for producing the substrate can include additional components which influence its chemical and physical properties. For example, the plastic material includes a suitable filler.

Exemplary metals with which the plastic material is coated include aluminum, steel, nickel, and alloys of said metals. The metal can be a metal that can be heated by induction, for example, an electromagnetic alternating field of an induction coil.

The metal can be in untreated form, or it can have been pretreated with appropriate agents, for example, to prevent corrosion or to improve adhesion.

The metal with which the plastic material is coated can be attached in any desired manner to the plastic material. For example, the attachment can occur by mechanical attachment means, such as nails, screws, rivets, mechanical clips, clamps, crimping or the like, or by gluing the metal to the plastic material. The metal can also have been applied by plastic galvanization on the plastic material. In an exemplary embodiment, the layer thickness of the metal layer on the plastic material substrate can be 0.03-1.5 mm.

The substrate, which can be made of a plastic material and which can be coated with a metal, can present an exemplary benefit, in comparison to a pure metal substrate, that it is lighter, on the one hand, and that, on the other hand, owing to the properties of the plastic material, such as the selection of the material and its processing, it can be modified within a very broad range in terms of its mechanical properties and its design. An exemplary benefit of the metal coating compared to a substrate made purely of a plastic material is that the metals can be more adhesive. An additional exemplary benefit of the metal coating is that in the case of thermosetting structural adhesives, the metal layer can be heated locally and efficiently by induction.

The substrate can have any desired configuration and any desired structure. For example, it can be solid, hollow or foamed, or it can have a lattice-like structure. The surface of the substrate, for example, of the plastic material or of the metal, can be smooth, rough or structured. The substrate can be fiber reinforced.

In addition to its exemplary function as a substrate for the structural adhesive, the substrate can contribute to the structural reinforcement or to the sealing of the component or also to noise damping.

The substrate can comprise an attachment means, for example, a clip, for the attachment and positioning of the reinforcing element in a cavity. The attachment of the reinforcing element with a clip can be suitable, for example, in applications in which it is desirable for the entire surface of the component, for example, including the cavity inner wall, to be accessible, for example, for immersion lacquering. For example, in such cases, an attachment, for example, by gluing may not be appropriate, because the lacquer may not reach the site of the gluing.

The preparation of the substrate can be carried out using the injection molding method.

The thermosetting structural adhesive can be an epoxy resin composition or a polyurethane composition.

In a first exemplary embodiment, the thermosetting structural adhesive is a foamable thermosetting structural adhesive. The thermosetting structural adhesive can be foamed in any desired manner. It can be desirable to ensure that the foaming process occurs substantially before the curing of the structural adhesive.

Such a foamable structural adhesive can include a chemical or a physical propellant. Chemical propellants can include organic or inorganic compounds that decompose under the action of temperature, humidity or electromagnetic radiation, wherein at least one of the degradation products is a gas. As physical propellants one can use, for example, compounds that are converted to the gaseous state when the temperature is increased. In this manner, chemical as well as physical propellants can be produced in the layer of foam structures in polymers.

The foamable structural adhesive can be thermally foamed, wherein chemical propellants are used. Examples of suitable chemical propellants include azodicarbonamides, sulfohydrazides, hydrogen carbonates, or carbonates.

Suitable exemplary chemical propellants are also commercially available, for example, under the trade name Celogen® from Chemtura Corp., USA.

Suitable exemplary physical propellants are commercially available, for example, under the trade name Expancel® from Akzo Nobel, Netherlands.

The heat employed for the foaming can be introduced using external or internal heat sources such as, for example, an exothermic chemical reaction. The foamable material can be foamable at a temperature of, for example, ≦160° C., for example, 80-150° C., for example, 90-140° C.

In a second exemplary embodiment, the thermosetting structural adhesive is a shape memory material.

In an exemplary embodiment, a shape memory material includes, besides the thermosetting structural adhesive, at least one elastomer which is in the form of a penetrating polymer network in the structural adhesive.

For example, if the thermosetting structural adhesive is a shape memory material based on an epoxy resin composition, said composition can have glass transition temperature T_{g} which is above room temperature.

For example, if the thermosetting structural adhesive is a shape memory material based on a polyurethane composition, then said composition can have a melting point which is above room temperature.

The indications on the glass transition temperature T_{g} refer to an exemplary embodiment of the composition in which the thermosetting structural adhesive is an epoxy resin composition, unless otherwise indicated. Accordingly, the indications on the melting point can relate to the embodiment in which the thermosetting structural adhesive is a polyurethane composition.

The glass transition temperature T_{g} as well as the melting points can be measured by DSC (Differential Scanning calorimetry), wherein the measurements can be carried out with a Mettler Toledo 822e apparatus at a heating rate of 10° C./min to 180° C. on 5-mg samples. The measured values can be determined using DSC software from the measured DSC curve.

The term “penetrating polymer network” can include a “semi-interpenetrating polymer network” (SIPN) according to the IUPAC Compendium of Chemical Terminology, 2nd Edition (1997). The SIPN includes at least one network as well as at least one linear or branched polymer, wherein said polymer penetrates the network at least partially. In an exemplary composition, the elastomer forms the network, and the polymer is a component of the thermosetting structural adhesive.

An exemplary composition which is a “shape memory material,” can be converted in its preparation or processing to a certain shape (“original shape”), and, after this shaping, it can have a solid consistency, for example, the structural adhesive can be present at a temperature below the glass transition temperature T_{g} or below its melting point. In this shape, the elastomer, which is present as penetrating polymer network in the structural adhesive, can be substantially unstressed. If desired, the composition can then be heated to a temperature above the glass transition temperature T_{g} or above the melting point of the structural adhesive, and converted to any desired shape (“temporary shape”). In this temporary shape, the elastomer can be in a stressed shape. The composition can be maintained in this temporary shape, and the temperature of the composition can again be lowered below the glass transition temperature T_{g} or below the melting point of the structural adhesive, whereby the composition solidifies in the temporary shape. In this temporary shape, the composition can be stable when stored, and it can be subjected to processing, for example, stamping or cutting. If the composition is heated at a later time again to a temperature which is above the glass transition temperature T_{g} or above the melting point of the structural adhesive, the elastomer can return to its unstressed shape, and thus deform the entire composition back to its original shape.

The elastomer present in an exemplary composition, which is in the form of a penetrating polymer network in the structural adhesive, is, for example, a thermoplastic elastomer. This thermoplastic elastomer can have a glass transition temperature T_{g} (elastomer) which is lower than the glass transition temperature T_{g} of the thermosetting structural adhesive.

For example, the thermoplastic elastomer has a melting point which is above the glass transition temperature T_{g} or the melting point of the thermosetting structural adhesive. The thermoplastic elastomer can have a melting point of 50-200° C., for example, 70-160° C.

The thermoplastic elastomer can have a molecular weight M_{w} (average weight) ≧50,000 g/mol, for example, 70,000-300,000 g/mol. In this molecular weight range, the thermoplastic elastomer can have an exemplary benefit that it is thermoplastically processable and presents good mechanical properties.

The thermoplastic elastomer can be selected from the group consisting of polyolefins and polyolefin copolymers. They can include, for example, polyethylene (PE), polypropylene (PP), ethylene vinyl acetate (EVA) and the like. It is also conceivable, for example, that a mixture of two or more elastomers can be present in the exemplary composition.

In the exemplary preparation of an exemplary composition, the thermosetting structural adhesive can be mixed at a temperature above its glass transition temperature T_{g} with the thermoplastic elastomer until a homogeneous mixture is obtained. The mixing of the thermosetting structural adhesive with the thermoplastic elastomer can occur, for example, at a temperature above the melting point of the elastomer, in an extruder, for example.

If the thermosetting structural adhesive is a thermosetting structural adhesive, the structural adhesive can be mixed with the elastomer prior to the addition of the curing agent. As a result, the temperature can be set during the mixing to or even above the curing temperature of the thermosetting structural adhesive, without any curing of the structural adhesive occurring. As a rule, a more efficient mixing can be achieved at higher temperatures.

For example, it is possible to use a non-thermoplastic elastomer instead of a thermoplastic elastomer. In an exemplary embodiment, the non-thermoplastic elastomer can have, for example, a glass transition temperature T_{g} (non-thermoplastic elastomer) which is lower than the glass transition temperature T_{g} of the thermosetting structural adhesive.

For example, a chemically crosslinked elastomer is synthesized from polymer polyols and polyisocyanates or from epoxy resins or amino- or carboxyl-terminated liquid rubbers.

A “chemically crosslinked elastomer” includes an elastomer which is crosslinked via covalent chemical bonds. In contrast, the crosslinking of a thermoplastic elastomer is based on physical interactions. For example, a chemically crosslinked elastomer differs from a thermoplastic elastomer in that, while it does indeed swell in an appropriate solvent, it is not dissolved. A thermoplastic elastomer, on the other hand, dissolves completely in a suitable solvent.

The presence of a chemically crosslinked elastomer can be determined, for example, on the basis of ASTM D 2765.

For example, if the elastomer is a non-thermoplastic elastomer, for example, a chemically crosslinked elastomer, an exemplary composition can be prepared by mixing the polymer components for the preparation of the elastomer, prior to its crosslinking with the thermosetting structural adhesive above its glass transition temperature T_{g}. When a homogeneous mixture has been achieved, the composition can then be converted back to its original shape, and the polymer components for the preparation of the elastomer can be crosslinked in this original shape to form an elastomer.

The use of a thermoplastic elastomer can have an exemplary benefit that the elaborate setting of a temperature range, in which the polymer components for the preparation of the elastomer are crosslinked to form the elastomer, is not necessary.

For example, the composition can be a shape memory material which is solid at room temperature (23° C.), which allows an optimal handling of the material in its original shape and in its temporary shape.

In order for an exemplary composition to be solid at room temperature, the thermosetting structural adhesive can have a glass transition temperature T_{g}, in the case of an epoxy resin composition, or a melting point, in the case of a polyurethane composition, which is above room temperature. For example, otherwise, the exemplary composition, after it has been converted to its temporary shape—the elastomer that is stressed in this temporary shape—may not be able to maintain this shape at room temperature.

For example, the thermosetting structural adhesive can be

an epoxy resin composition having a glass transition temperature T_{g} in the range of 23-95° C., for example, 30-80° C., for example, 35-75° C., or

a polyurethane composition having a melting point in the range of 23-95° C., for example, 30-80° C., for example, 35-75° C.

Furthermore, in an exemplary embodiment, the surface of an exemplary composition is not sticky at room temperature, which facilitates its handling.

The thermosetting structural adhesive can have a curing temperature in the range of 120-220° C., for example, 160-200° C.

For example, in the processing of the composition, in which it is converted to its temporary shape, it can be beneficial to ensure that the composition is not sufficiently heated for the curing process to start.

The thermosetting structural adhesive can be an epoxy resin composition comprising at least one epoxy resin A and at least one curing agent B for epoxy resins, which is activated by elevated temperature. For example, a single-component epoxy resin composition can be used.

The epoxy resin A can have more than one epoxy group per molecule on average, and it can be, for example, a solid epoxy resin or a mixture of a solid epoxy resin with a liquid epoxy resin. For example, the “solid epoxy resin” does not include a “liquid epoxy resin.” The glass transition temperature T_{g} of solid resins can be above room temperature.

Exemplary solid epoxy resins have the formula (I).

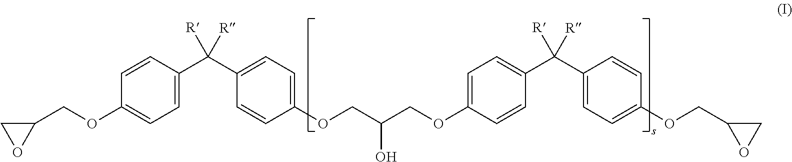

In an exemplary embodiment, the substituents R′ and R″ independently of each other stand for H or CH₃. The index s stands for a value ≧1, for example, ≧1.5, for example, 2 to 12.

Exemplary solid epoxy resins are commercially available, for example, from Dow Chemical Company, USA, from Huntsman International LLC, USA or from Hexion Specialty Chemicals Inc., USA.

Exemplary liquid epoxy resins, which can be used together with a solid epoxy resin, have the formula (II).

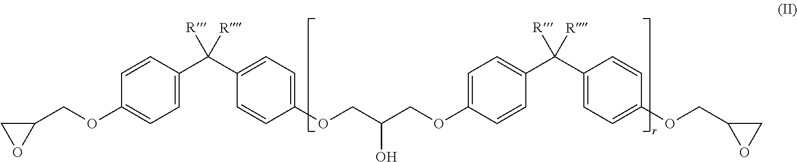

In an exemplary embodiment, the substituents R′″ and R″″ independently of each other stand for H or CH₃. The index r stands for a value from 0 to 1. An exemplary value of r is ≦0.2.

For example, diglycidyl ethers of bisphenol A (DGEBA), of bisphenol F as well as of bisphenol A/F can be used. The term “A/F” refers to a mixture of acetone with formaldehyde, which can be used as its starting material. Such exemplary liquid resins are commercially available, for example, under the trade names Araldite® GY 250, Araldite® PY 304, Araldite® GY 282 from Huntsman International LLC, USA, or D.E.R.® 331 or D.E.R.® 330 from Dow Chemical Company, USA, or under the trade name Epikote® 828 or Epikote® 862 from Hexion Specialty Chemicals Inc., USA.

For example, depending on the embodiment, the epoxy resin used as one of the starting compounds in the thermosetting structural adhesive can also be a liquid epoxy resin. This can be the case, for example, if the thermosetting structural adhesive comprises at least one chemically crosslinked elastomer for the formation of a shape memory material, wherein the chemical crosslinking of the polymer components for the preparation of this elastomer leads to an increase of the glass transition temperature T_{g} of the thermosetting structural adhesive, so that said temperature is in the appropriate range for handling the material. This can be the case, for example, if the chemically crosslinked elastomer is synthesized at least partially from the liquid epoxy resin used.

Additional exemplary suitable epoxy resins are so-called novolacquers. They can have, for example, the following formula (III).

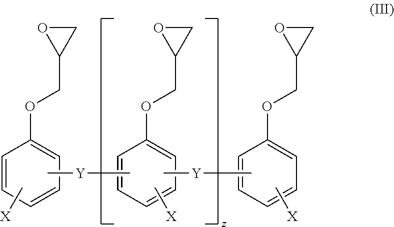

In an exemplary embodiment, the residue X stands for a hydrogen atom or for a methyl group. The residue Y stands for —CH₂— or for a residue of formula (IV).

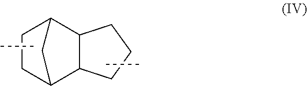

The index z stands for a value from 0 to 7, for example, for a value ≧3.

For example, phenol or cresol novolacquers are used (Y stands for —CH₂—).

Exemplary epoxy resins are commercially available under the trade name EPN or ECN as well as Tactix® 556 from Huntsman International, LLC, USA, or under the product series D.E.N.™ from Dow Chemical Company, USA.

The epoxy resin A can be a solid epoxy resin of formula (I). In another exemplary embodiment, the thermosetting epoxy resin composition contains both at least one solid epoxy resin of formula (I) and also at least one liquid epoxy resin of formula (II).

The proportion of epoxy resin A can be 2-90 wt %, for example, 5-70 wt %, for example, 10-60 wt %, with respect to the total weight of the thermosetting structural adhesive.

The curing agent B for epoxy resins can be activated by elevated temperature. The curing agent B can be a curing agent which is selected from the group consisting of dicyandiamide, guanamines, guanidines, aminoguanidines, and their derivatives; substituted ureas, for example, 3-(3-chloro-4-methylphenyl)-1,1-dimethylurea (chlortoluron) or phenyl-dimethylurea, for example, p-chlorophenyl-N,N-dimethylurea (monuron), 3-phenyl-1,1-dimethylurea (fenuron), 3,4-dichlorophenyl-N,N-dimethylurea (diuron), as well as imidazoles and amine complexes.

It can be exemplary to use dicyandiamide as curing agent B, for example, in combination with a substituted urea. An exemplary benefit of the combination of dicyandiamide with a substituted urea resides in the resulting accelerated curing of the composition.

The proportion of the curing agent B can be 0.05-8 wt %, for example, 0.1-6 wt %, for example, 0.2-5 wt %, with respect to the total weight of the thermosetting structural adhesive.

The term “curing agent” can include catalysts and catalytically acting compounds. For example, when using a catalyst or a catalytically active compound as curing agent B, the proportion of the curing agent B in the entire thermosetting structural adhesive can be in the lower range of the indicated range of values.

In addition, the epoxy resin composition can comprise at least one impact resistance modifier.

An “impact resistance modifier” can include an addition of an organic polymer to an epoxy resin matrix, which in small quantities, for example, quantities of 0.1-20 wt %, can result in a clear increase in toughness, and a capability of absorbing higher impact or shock loads, before the matrix tears or ruptures.

As impact resistance modifiers, reactive liquid rubbers based on nitrile rubber or derivatives of polyether polyol-polyurethanes, core shell polymers, or similar suitable systems can be used.

Suitable exemplary impact resistance modifiers are described as impact resistance modifiers D in European patent application No. EP 08168009.2, the entire content of which is hereby incorporated by reference in its entirety.

For example, the impact resistance modifier is a non-thermoplastic elastomer.

For example, also suitable is the thermosetting structural adhesive including a single-component thermosetting polyurethane composition which has a solid consistency at room temperature.

Single-component thermosetting polyurethane compositions which have a solid consistency at room temperature can present different curing mechanisms.

In a first exemplary embodiment, polyurethane compositions are used, which comprise, besides a solid, isocyanate group-terminated, polyurethane polymer, also at least one aldimine, for example, a polyaldimine, as curing agent. During an increase in temperature, and the resulting softening of the polyurethane polymer, water, for example, in the form of air humidity, can penetrate into the polyurethane composition, resulting in the hydrolysis of the aldimines and consequently the release of amines, which then react with the isocyanate groups and lead to the curing of the compositions.

For example, suitable thermosetting polyurethane compositions of this type are described in WO 2008/059056 A1, the entire content of which is hereby incorporated by reference in its entirety.

In a second exemplary embodiment, polyurethane compositions can be used, which also comprise, besides an isocyanate group-terminated polyurethane polymer, at least one curing agent, which optionally contains groups that react with isocyanates, and which is in blocked form. The blocking here can be of chemical or physical nature. Examples of suitable chemically blocked curing agents are polyamines bound by complexing to metals, for example, complex compounds of methylenedianiline (MDA) and sodium chloride. Such complex compounds are usually described using the empirical formula (MDA)₃.NaCl. A suitable exemplary type is available as a dispersion in diethylhexyl phthalate under the trade name Caytur® 21 from Chemtura Corp., USA. The complex decomposes when heated at 80-160° C. at a rate which increases with higher temperature, whereby methylenediamine is released as active curing agent. Examples of physically blocked curing agents are microencapsulated curing agents. For example, the following are suitable as curing agents in microencapsulated form: bivalent or polyvalent alcohols, short-chain polyester polyols, aliphatic, cycloaliphatic and aromatic amino alcohols, hydrazides of dicarboxylic acids, aliphatic polyamines, cycloaliphatic polyamines, ether group-containing aliphatic polyamines, polyoxyalkylene-polyamines which are available, for example, under the name Jeffamine® (from Huntsmann International LLC, USA), and aromatic polyamines. Aliphatic, cycloaliphatic and aromatic polyamines, for example, ethanolamine, propanolamine, butanolamine, N-methylethanolamine, diethanolamine, and triethanolamine, can be used.

A detailed listing of suitable curing agents for use in microencapsulated form can be found, for example, on page 14, starting at line 25, in WO 2009/016106 A1, the entire content of which is hereby incorporated by reference in its entirety.

For example, the microencapsulation of these curing agents can be carried out using any suitable process, for example, by spray drying, boundary polymerization, coacervation, immersion or centrifugation processes, fluidized bed processes, vacuum encapsulation, and electrostatic microencapsulation. The microcapsules so obtained can have a particle size of 0.1-100 μm, for example, 0.3-50 μm. The size of the microcapsules can be chosen such that, on the one hand, they open effectively when heated, and, on the other hand, after the curing, optimal homogeneity and consequently cohesive strength of the structural adhesive are obtained. In an exemplary embodiment, they do not have a detrimental influence on the adhesion properties of the structural adhesive. As material for the capsule sheath, one can consider using polymers that are insoluble in the curing agent to be encapsulated and have a melting point of 50-150° C. Examples of suitable polymers are hydrocarbon waxes, polyethylene waxes, wax esters, polyesters, polyamides, polyacrylates, polymethacrylates or mixtures of several such polymers.

In a third exemplary embodiment, isocyanate group-terminated polyurethane polymers can be used, whose isocyanate groups have been reacted with thermally unstable blocking groups, such as, for example, with caprolactam, or with blocking groups whose isocyanate groups have been dimerized to thermally unstable uretidiones.

In a fourth exemplary embodiment, polyurethane compositions can be used which include, besides a hydroxyl group-terminated polyurethane polymer and/or at least one polymer polyol, as described above, at least one encapsulated or surface deactivated polyisocyanate as curing agent. Exemplary encapsulated or surface deactivated polyisocyanates are described in EP 0 204 970 or EP 0 922 720, for example, the entire contents of which are hereby incorporated by reference in its entireties. The above described polyisocyanates can be suitable.

For example, if the thermosetting structural adhesive is a polyurethane composition, the components for the production thereof, for example, the polyisocyanate and the polyol, can be selected, for example, in terms of their molecular weight and their functionality, in such a manner that the polyurethane has a melting point above room temperature, for example, in the range of 23-95° C.

The thermosetting structural adhesive can contain additional components, such as, for example, those used in thermosetting structural adhesives. For example, the thermosetting structural adhesive additionally contains at least one filler. Exemplary fillers include mica, talc, kaolin, wollastonite, feldspar, syenite, chlorite, bentonite, montmorillonite, calcium carbonate (precipitated or ground), dolomite, quartz, silicic acids (pyrogenic or precipitated), cristobalite, calcium oxide, aluminum hydroxide, magnesium oxide, hollow ceramic beads, hollow glass beads, hollow organic beads, glass beads, and color pigments. Fillers can include both the organically coated and also the uncoated forms which are commercially available. An additional example includes functionalized alumoxanes, as described in U.S. Pat. No. 6,322,890, for example, the entire content of which is hereby incorporated by reference in its entirety.

The proportion of the filler can be 1-60 wt %, for example, 5-50 wt %, for example, 10-35 wt %, with respect to the weight of the entire thermosetting structural adhesive.

As additional components, the thermosetting structural adhesive can include, for example, thixotropic agents, such as, for example, aerosils or nanoclays, impact resistance modifiers, reactive diluents as well as other suitable components.

In an exemplary embodiment, a single-component thermosetting epoxy resin composition can be used as thermosetting structural adhesive.

The exemplary production of exemplary reinforcing elements can be carried out in different manners depending on the embodiment of the reinforcing element. For example, in a first step, a substrate made of a plastic material in the desired form can be made available. Said substrate can then be provided with a metal coating in a second step. As already described above, this can occur in any suitable manner.

In an exemplary method, a thermosetting structural adhesive is made available, which is then modified, for example, by admixing a propellant, to produce a foamable, thermosetting structural adhesive. This foamable, thermosetting structural adhesive is subsequently applied at least partially to the metal coating of the substrate.

For example, if the metal coating is not applied by plastic galvanization on the substrate, but is already present in the form of sheet metal or the like, the reinforcing element can also be produced by coating the metal with the foamable, thermosetting structural adhesive. Subsequently, from the composite of metal and structural adhesive, shapes can be cut out or punched out, which again are applied to a substrate present in the appropriate shape.

For example, it is also possible to produce reinforcing elements which have a thermosetting structural adhesive as shape memory material. For example, the metal, in its original shape, in the form of sheet metal or the like, is first coated in this case with the thermosetting structural adhesive comprising at least one elastomer which is in the form of a penetrating polymer network in the structural adhesive. After the coating, the structural adhesive on the metal, as described above, can then be converted to its temporary shape, for example, by pressing, rolling or the like, at elevated temperature, and subsequently cooled in this shape. Subsequently, shapes can again be cut out or punched out of the composite of the metal and the structural adhesive, and then applied to a substrate present in the appropriate form.

FIG. 1 is a schematic representation of a cross-section of an exemplary reinforcing element comprising a substrate 1 made of a plastic material, which is coated with a metal 2. Located as shape memory material in its temporary shape on the metal layer is a thermosetting structural element 3, which is a foamable, thermosetting structural adhesive or a thermosetting structural adhesive.

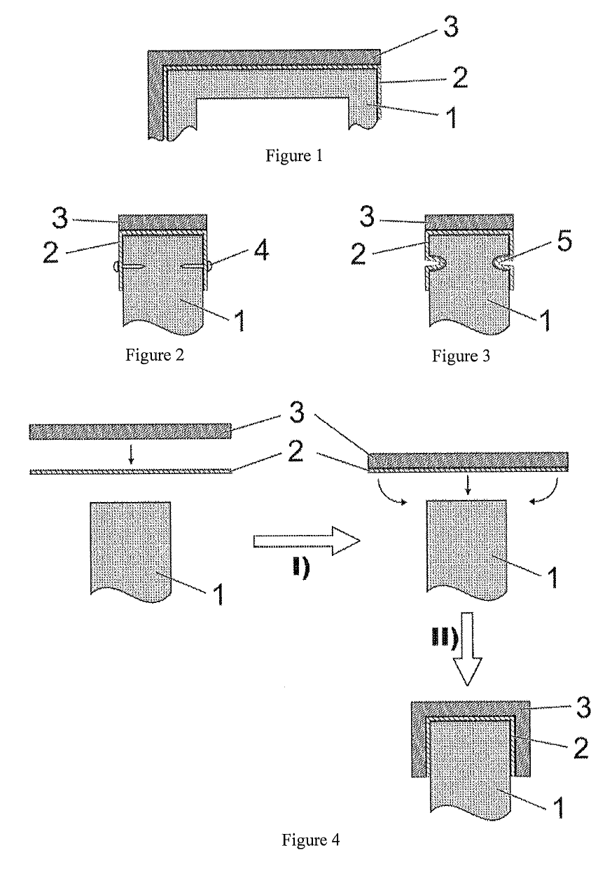

FIGS. 2 and 3, like FIG. 1, show exemplary reinforcing elements with substrate 1, metal 2, and thermosetting structural adhesive 3, wherein FIG. 2 shows the attachment of the metal on the substrate by means of nails 4 and FIG. 3 shows the attachment of the metal on the substrate by crimping 5.

FIG. 4 is a schematic representation of an exemplary method for producing an exemplary reinforcing element wherein, in a first step I), a thermosetting structural adhesive 3, which is a foamable, thermosetting structural adhesive or a thermosetting structural adhesive, is applied, as shape memory material in its temporary shape, to a metal 2. In a second step II), the metal together with the thermosetting structural adhesive is then adapted and applied to the substrate 1.

According to an exemplary aspect, provided is the use of an exemplary reinforcing element, for the reinforcement of cavities of structural components. Such structural components can be used in car bodies and/or in frames of transport and conveyance means, for example, of land or aquatic vehicles, or of airplanes. The disclosure can comprise the use of a reinforcing element in bodies or frames of automobiles, trucks, railroad cars, boats, ships, helicopters and airplanes, for example, in automobiles.

A further exemplary aspect relates to a method for the reinforcement of cavities in structural components, comprising the steps of a) placing an exemplary reinforcing element in the cavity of a structural component; b) heating the thermosetting structural adhesive on the reinforcing element to a temperature above the glass transition temperature T_{g} of the thermosetting structural adhesive, and wherein this temperature is the foaming temperature of the foamable, thermosetting structural adhesive, or this temperature is the temperature at which the shape memory material returns to its original shape; and c) curing the thermosetting structural adhesive.

For example, the substrate of the reinforcing element comprises a metal coating which can be heated by induction, wherein the steps b) and c) are carried out using an electromagnetic alternating field of an induction coil.

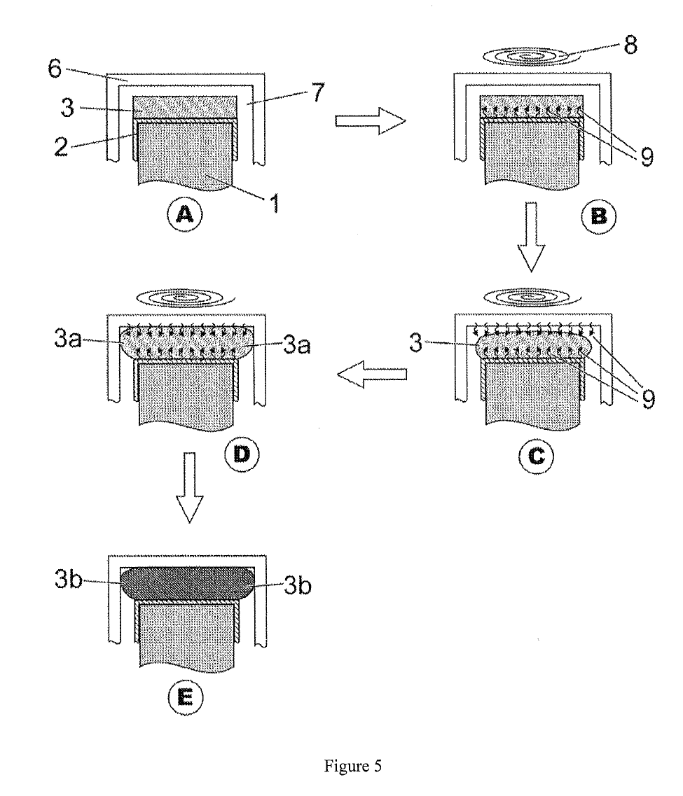

FIG. 5 is a schematic representation of the exemplary reinforcement of a cavity 7 of a structural component 6, wherein A in FIG. 5 shows a reinforcing element applied inside a structural component including a substrate 1 made of a plastic material which is coated with a metal 2, and of a thermosetting structural adhesive 3, which is a foamable, thermosetting structural adhesive or a thermosetting structural adhesive, as shape memory material in its temporary shape. By application of an electromagnetic alternating field of an induction coil 8, the metal portions located within the reach of the alternating field heat up, as a result of which heat 9 is released to the structural adhesive, as shown in B of FIG. 5. As a result of the action of the heat, the deformation of the thermosetting structural adhesive starts, i.e., the foaming process, or the transition of the shape memory material to its original shape starts, depending on the embodiment. In the case of advanced expansion or deformation of the thermosetting structural adhesive, the latter also reaches the area where it prior to the heat, which the electromagnetic alternating field of the induction coil 8 generates in the structural component 6, as shown in C of FIG. 5. After completion of the expansion or deformation of the thermosetting structural adhesive 3a, the curing of the thermosetting structural adhesive starts, under the continued and increased influence of the electromagnetic alternating field. This is shown in D of FIG. 5. Finally, E of FIG. 5 shows the completely cured structural adhesive 3b and the reinforced structural component 6.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE NUMERALS

1 Substrate
2 Metal
3 Thermosetting structural adhesive, unfoamed or in temporary shape
3a Thermosetting structural adhesive, after expansion or deformation
3b Cured structural adhesive
4 Nail
5 Crimping
6 Structural component
7 Cavity
8 Induction coil
9 Heat

What is claimed is:

1. A reinforcing element for reinforcement in cavities of structural components, comprising:
a) a substrate made of a plastic material, which is coated at least partially with a metal; and
b) a foamable, thermosetting structural adhesive applied to the metal coating of the substrate, or a thermosetting structural adhesive which is applied to the metal coating of the substrate and which is designed as a shape memory material.

2. The reinforcing element according to claim 1, wherein the metal is selected from the group consisting of aluminum, steel, an alloy of iron, an alloy of aluminum, an alloy of iron and aluminum, and a combination thereof.

3. The reinforcing element according to claim 1, wherein the metal is a metal that can be heated by induction.

4. The reinforcing element according to claim 1, wherein the metal coating has a layer thickness of 0.03-1.5 mm.

5. The reinforcing element according to claim 1, wherein the metal is attached to the plastic material by at least one mechanical attachment device.

6. The reinforcing element according to claim 1, wherein the metal is glued to the plastic material.

7. The reinforcing element according to claim 1, wherein the thermosetting structural adhesive has a glass transition temperature T_{g} in a range of 23-95° C.

8. The reinforcing element according to claim 1, wherein the thermosetting structural adhesive has a curing temperature of 120-220° C.

9. The reinforcing element according to claim 8, wherein the thermosetting structural adhesive is selected from the group consisting of an epoxy resin composition and a polyurethane composition.

10. The reinforcing element according to claim 9, wherein the thermosetting structural adhesive is an epoxy resin composition comprising at least one epoxy resin A and at least one curing agent B for epoxy resins, which is activated by elevated temperature.

11. The reinforcing element according to claim 1, wherein the thermosetting structural adhesive, which is designed as a shape memory material, contains an elastomer which is present in a form of a penetrating polymer network in the structural adhesive.

12. A method for reinforcement in cavities of structural components, the method comprising:
a) placing the reinforcing element according to claim 1 in a cavity of a structural component;
b) heating the thermosetting structural adhesive of the reinforcing element to a temperature above the glass transition temperature T_{g} of the thermosetting structural adhesive,
wherein the temperature at which the thermosetting structural adhesive is heated is a foaming temperature of the foamable, thermosetting structural adhesive, or the temperature at which the thermosetting structural adhesive is heated is a temperature at which the shape memory material returns to its original shape; and
c) curing the thermosetting structural adhesive.

13. The method according to claim 12, wherein the metal coating of the substrate of the reinforcing element can be heated by induction, wherein the steps b) and c) are carried out using an electromagnetic alternating field of an induction coil.

14. The method according to claim 12, wherein the temperature at which the thermosetting structural adhesive is heated is a foaming temperature of the foamable, thermosetting structural adhesive, and wherein the heat employed for the foaming is introduced using an exothermic chemical reaction.

15. The method according to claim 12, wherein the temperature at which the thermosetting structural adhesive is heated is a foaming temperature of the foamable, thermosetting structural adhesive, and wherein the foamable material is foamable at a temperature of 80-150° C.

16. The reinforcing element according to claim 1, wherein the metal is at least mechanically attached to the plastic material.

17. The reinforcing element according to claim 1, wherein the metal is attached to the plastic material by nails, screws, rivets, clips, clamps, crimping or a combination thereof.

18. The reinforcing element according to claim 1, wherein the reinforcing element includes the foamable, thermosetting structural adhesive applied to the metal coating of the substrate, and wherein the foamable, thermosetting structural adhesive includes a chemical or a physical propellant.

19. The reinforcing element according to claim 1, wherein the plastic material comprises a polyurethane, polyamide, polyester, polyolefin, polyolefin copolymer, poly(phenylene ether), polysulfone, polyether sulfone, polyethylene, polypropylene, polystyrene, copolymer of polystyrene or a combination thereof.
